(19) United States
(12) Patent Application Publication
(10) Pub. No.: US 2021/0191398 A1
(43) Pub. Date: Jun. 24, 2021

(54) System and Methods for Automated Detection of Vehicle Cabin Events for Triggering Remote Operator Assistance

(71) Applicant: Uber Technologies Inc., San Francisco, CA (US)

(72) Inventors: Sean Shanshi Chen, San Francisco, CA (US); Samann Ghorbanian-Matloob, San Francisco, CA (US); Michael Guanran Huang, San Francisco, CA (US); Robert Eperjesi, San Francisco, CA (US); Benjamin Ryan Ulrich, Fremont, CA (US)

(21) Appl. No.: 16/829,820

(22) Filed: Mar. 25, 2020

Related U.S. Application Data
(60) Provisional application No. 62/951,754, filed on Dec. 20, 2019.

(51) Int. Cl. G05D 1/00; B60W 60/00; G05D 1/02

(52) U.S. Cl. CPC G05D 1/0088; B60R 11/04; G05D 1/0276; B60W 60/001

(57) ABSTRACT

The present disclosure is directed to autonomous vehicle service assignment simulation using simulated remote operators. In particular, a computing system comprising one or more computing devices can obtain sensor data associated with an interior of an autonomous vehicle. The computing system can determine using the sensor data that the interior of the autonomous vehicle contains one or more passengers. In response to determining that the interior of the autonomous vehicle contains one or more passengers, the computing system can analyze the sensor data to determine whether the one or more passengers are violating one or more passenger policies. In response to determining that the one or more passengers are violating one or more passenger policies, the computing system can automatically initiate a remote assistance session with a remote operator.

### RELATED APPLICATION

This application claims priority to and the benefit of U.S. Provisional Patent Application No. 62/951,754, filed Dec. 20, 2019, which is hereby incorporated by reference in its entirety.

### FIELD

The present disclosure relates generally to autonomous vehicles. More particularly, the present disclosure relates to the planning of movement of autonomous vehicles through an environment.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path for navigating through the surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining sensor data associated with an interior of an autonomous vehicle. The method can include determining using the sensor data that the interior of the autonomous vehicle contains one or more passengers. The method can include, in response to determining that the interior of the autonomous vehicle contains one or more passengers, analyzing the sensor data to determine whether the one or more passengers are violating one or more passenger policies. The method can include, in response to determining that the one or more passengers are violating one or more passenger policies, automatically initiating a remote assistance session with a remote operator.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of an example autonomous vehicle according to example embodiments of the present disclosure.

FIG. 2 depicts a block diagram of an example motion service system according to example embodiments of the present disclosure.

FIG. 3 depicts a block diagram of an example remote assistance system according to example embodiments of the present disclosure.

FIG. 4 depicts a block diagram of an example passenger monitoring system according to example embodiments of the present disclosure.

FIG. 5 is a representation of a camera view of a passenger in the interior of an autonomous vehicle according to example embodiments of the present disclosure.

FIG. 6 is a representation of a camera view of a passenger in the interior of an autonomous vehicle according to example embodiments of the present disclosure.

FIG. 7 depicts a flow chart diagram of an example method according to example embodiments of the present disclosure.

FIG. 8 depicts an example system with units for performing operations and functions according to example aspects of the present disclosure.

FIG. 9 depicts example system components according to example aspects of the present disclosure.

### DETAILED DESCRIPTION

Generally, the present disclosure is directed to an automated monitoring system that can be used to detect when one or more passengers in an autonomous vehicle have violated one or more passenger policies and automatically generating a remote assistance session in response. For example, the provider of an autonomous vehicle (e.g., a service entity that provides autonomous vehicle services to passengers and other users) may want to ensure that passengers in the autonomous vehicle comply with one or more policies set by the service provider or owner of the autonomous vehicle. To do so, the autonomous vehicle can include a monitoring system. The monitoring system can capture interior sensor data from the interior of the cabin of the autonomous vehicle. For example, the interior sensor data can include image data and audio data captured from interior of the autonomous vehicle. Using this interior sensor data, the monitoring system can generate information about objects and passengers in the autonomous vehicle, including, but not limited to, whether or not any passengers are present, whether there are any identifiable objects present, the location of any passengers, and the activities any of the passengers are engaged in. The monitoring system can determine, based on the generated information about objects and passengers, whether any of the passengers are violating the passenger policies. If so, the monitoring system can cause a remote assistance session to be initiated with a remote operator.

The systems and methods of the present disclosure provide techniques for allowing a monitoring system associated with an autonomous vehicle to enact the policies of a service entity. More particularly, a monitoring system can obtain interior sensor data associated with the interior of an autonomous vehicle. The interior sensor data can include image data from a camera, audio data from a microphone, infrared data from an infrared data sensor, point cloud data from an interior LIDAR sensor, as well as other data from other sources. The monitoring system can analyze the interior sensor data to determine that the cabin of the autonomous vehicles includes one or more passengers.

Once the system has determined that the cabin includes one or more passengers, the monitoring system can analyze the interior sensor data to determine whether one or more passengers are violating a passenger policy. For example, the monitoring system can use one or more algorithms, rules, models, or heuristics to analyze the interior sensor data to identify one or more prohibited objects (e.g. weapons improperly stored, lit cigarettes, and so on) or one or more passenger scenarios. For example, the monitoring system can employ a machine-learned model that takes one or more images as input. The machine-learned model can be trained (using reference images) to identify one or more joint positions for the passengers. Using the joint positions, the machine-learned model (or a different machine-learned model) can generate an estimated location and pose for each passenger in the autonomous vehicle. Using this information, the monitoring system can determine the movement of the passengers over time. The movement of the passengers can be analyzed to identify that one or more passengers are engaged in a particular activity. The activities that passengers can engage in are associated with one or more scenarios. The monitoring system can determine a particular scenario in which the passengers are involved. The particular scenario can be compared to a list of prohibited scenarios. If the monitoring system determines that one or more passengers are involved in a prohibited scenario (and thus are violating a passenger policy), the monitoring system can automatically initiate a remote assistance session with a remote operator.

In some example embodiments, the remote assistance session can be associated with a remote assistance service. The remote assistance service can be implemented by a remote assistance system which receives one or more requests for remote assistance from an autonomous vehicle (e.g., automatically generated in response to one or more detected problems) or a passenger in an autonomous vehicle (e.g., via an electronic device associated with the passenger such as a smartphone or tablet computer). By way of example, an autonomous vehicle may determine that a passenger has violated one or more passenger policies (e.g., sticking a limb out of a window). In response, the autonomous vehicle (or a monitoring system included in the autonomous vehicle) can initiate a remote assistance session with a remote operator. Thus, the autonomous vehicle can send (e.g., via its onboard communication system) a communication including a request to initiate a remote assistance session to the remote assistance system. In other examples, the monitoring system can be remote from the autonomous vehicle and receive sensor data from the autonomous vehicle to monitor for violations of passenger policies.

In some example embodiments, the remote assistance request can be first transmitted to a remote assist application programming interface (API), which allows autonomous vehicles access to contact the autonomous vehicle services system (and, in this case specifically, the remote assistance system). In some examples, the remote assist API can provide a standardized interface for sending requests for remote assistance regardless of the particular autonomous vehicle transmitting the request. Thus, third-party owned autonomous vehicles can also transmit requests to the remote assist API, either directly or via a system controlled by the third-party before being relayed to the remote assist API.

The remote assist API can transmit (or facilitate the transmittal) of the request for remote assistance to the autonomous vehicle services system. The autonomous vehicle services system can direct the request to the remote assistance system. In another example, the remote assist API can transmit the request directly to the remote assistance system via the communication system.

The remote assist API can help the monitoring system to request specific sensor data from an autonomous vehicle. For example, in some examples, the monitoring system can determine that specific data is needed from specific sensors in an autonomous vehicle to ensure that passenger behavior is properly monitored. In one example, the monitoring system can determine that image data from two internal cameras in an autonomous vehicle at a high frame rate (e.g., because of a poor-light environment).

To assist the monitoring system in determining what data can be obtained from an autonomous vehicle, the back-end autonomous vehicle services system can account for the various media capabilities of the various autonomous vehicles that are online with the service entity. For example, the back-end autonomous vehicle services system can describe the image data requirements (e.g., video stream requirements) for a particular situation. For example, the back-end autonomous vehicle services system can request (or require) that a 1080 p, 10 fps video stream is required to adequately monitor passengers inside a particular autonomous vehicle. The back-end autonomous vehicle services system can make these requirements available to autonomous vehicles by employing a “streammediarequirements” remote procedural call (RPC) (e.g., a server-side streaming RPC) or “GetMediaConfigurations RPC (e.g., a unary RPC). Autonomous vehicles can then call the appropriate RPC to determine the media requirements of the back-end autonomous vehicle services system. Autonomous vehicles can call one or both RPCs to determine the requirements of the back-end autonomous vehicle services system. The autonomous vehicle can make its best effort to meet those requirements (i.e., if the vehicle only has a 720 p camera, it may stream up a 720 p 10 fps video stream).

in some examples, the back-end autonomous vehicle services system can determine whether to require a consistent stream of data (e.g., via the streaming RPC) or to rely on a polling RPC (e.g., via the unary RPC). In some examples, this determination can be based on input from a user via an API.

Upon receiving a request for remote assistance from an autonomous vehicle, the remote assistance system can assign an operator to assist the requesting autonomous vehicle. In some example embodiments, the request for remote assistance may also be associated with particular request parameters. For example, the associated request parameters can include information identifying the specific autonomous vehicle, incident data associated with the request (e.g., which policy was violated), information about the capabilities of the vehicle, the vendor that owns the vehicle, information describing autonomous driving software that is currently operating the autonomous vehicle, and the specific remote assistance actions that are available to the remote assistance system.

Incident data can include situational data for the autonomous vehicle. Situational data can include data describing the current situation of the vehicle including location, heading, velocity, the number and identities of passengers, and the data from any sensors included in the autonomous vehicle. Such sensors can include but are not limited to internal and external cameras, LIDAR sensors, and radar sensors. Also, the incident data can identify what policy was broken, where and how the violation occurred, and which passenger committed the violation.

The remote assistance system is associated with a plurality of computer systems. One of the computer systems can be associated with the assigned remote operator for a particular remote assistance session. The remote assistance system can display, in a remote assistance user interface at the computer system of an operator, some or all of the vehicle, situation, and incident data accessed based on the request. For example, the user interface can include camera views relevant to the current situation (e.g., cameras that capture visual data from inside the cabin of the autonomous vehicle) as well as any captured audio data that may be relevant, and any other relevant interior sensor data.

The remote operator can, through a remote assistance user interface, select a response option and/or communicate with the passengers of the vehicle. For example, the remote operator can direct the autonomous vehicle to pull over to the side of the road to allow for a resolution to the passenger behavior that violated one or more passenger policies. In addition, the remote operator can communicate with the passengers, explaining the current situation and requesting their help to resolve the situation.

The commands selected by the remote operator can be transmitted via the communication system to the autonomous vehicle (through the remote assist API) as a control command.

In some example embodiments, interior sensors can gather data about the interior of an autonomous vehicle. For example, a camera can capture image data and a microphone can capture audio data, both the image data and the audio data being associated with the interior of a vehicle. In some examples, the gathered data can be transmitted to a data analysis system. The data analysis system can be located in the autonomous vehicle itself. In other examples, the data analysis system can be located remotely from the autonomous vehicle and the interior sensor data can be transmitted to the remotely located data analysis system.

In some examples, the data analysis system can include a body pose estimation system and an object detector. Each subsystem can analyze interior sensor data to determine one or more characteristics of the interior of the autonomous vehicle. In some examples, the data analysis system can determine whether or not there are any passengers located in the autonomous vehicle. If at least one passenger is determined to be located inside the interior of the autonomous vehicle, the data analysis system can determine whether that passenger is following one or more passenger policies. For example, the object detector can analyze the image data to identify a list of objects present in the interior of the autonomous vehicle.

The body pose estimation system can use image data from the one or more interior sensors to determine the location and pose of a particular passenger's body. In some examples, the process for determining a location and pose of a passenger's body can include using image data to identify one or more joint positions. The joint positions of a user's body can be compared to reference data to identify the most likely position and pose for the passenger's body.

The data analysis system can capture a series of sequential images that represent one or more passengers inside the interior of an autonomous vehicle. The body pose estimation system can generate an estimated location and pose for each passenger through the series of sequential images. Based on the changes in the user's body position and pose, the body pose estimation system can estimate the movement of one or more passengers over time. Once the data analysis system has fully analyzed the interior sensor data (e.g., image data or audio data), the data analysis system can transmit the results of the analysis to the action evaluation system. In some examples, the transmitted results can include a list of objects determined to be present by the object detector.

The action evaluation system can use the data produced by the data analysis system to determine whether or not the one or more passengers are in violation of one or more policies stored in the policy database. For example, the action evaluation system can, for each object in the list of objects, determine whether the item is allowed based on data stored in the policy database. In some examples, the action evaluation system may also determine how the object is stored and whether it is being used. This information can be used to determine whether the user is violating a policy. For example, some objects may be allowed if stored properly but disallowed if not stored properly. An antique samurai sword stored properly may be allowed while an openly carried machete may be in violation of policy.

Similarly, a user smoking a cigarette or using a vaping device may be in violation of policy but merely possessing those items may not be in violation of the policy. In some examples, items may be in violation of the policy regardless of how they are stored or used. For example, a passenger policy for a particular autonomous vehicle may indicate that no firearms are allowed in the autonomous vehicle, regardless of how they are stored. Thus, the action evaluation system can determine which objects are present and whether the user has properly stored the object to fully determine whether one or more policies have been violated.

In some examples, the action evaluation system can also determine whether a user's actions violate a policy. Specific examples of policies the users may violate can include restrictions on what areas of the autonomous vehicle the user may access during the transportation service, restrictions on the interactions that are allowable between passengers, restrictions on damaging or otherwise negatively affecting the autonomous vehicle, and so on.

For example, a given autonomous vehicle may restrict which seats passengers are permitted to use. In some examples, the policies set by the owner or manager of an autonomous vehicle can designate that the driver's seat and the passenger seat of an autonomous vehicle are out of bounds for passengers during the transportation service. Thus, if a user attempts to sit in either seat, the action evaluation system can determine that the passenger is in violation of one or more policies. In some examples, the policies may restrict passengers from a first set of areas during the transportation service (e.g., while the autonomous vehicle is driving) and from a second set of areas before or after the transportation service. For example, a policy may allow a passenger to access an area of the autonomous vehicle to stow items (e.g., a trunk) but not allow the passenger to access that area while the autonomous vehicle is in motion.

In another example, the policies may prohibit violent altercations between two different passengers. The action evaluation system can use the body pose estimation data to determine whether two passengers are currently involved in a violent altercation. In some examples, determining the movement of each passenger can allow the action evaluation system to determine whether the users are involved in a violent altercation or are involved in acceptable behavior. In some examples, other data such as audio data can be used to distinguish unacceptable behavior from acceptable behavior.

Other examples can include a passenger sticking their arms or other objects out the windows of a vehicle or through a sunroof. The action evaluation system can determine whether or not a user has put a limb or other body parts or objects out of the vehicle in a way that is determined to be unsafe or in violation of one or more policies. In another example, the action evaluation system can determine that a passenger is damaging the autonomous vehicle and is thus in violation of a passenger policy.

It should be noted that this action evaluation system can be used to identify situations other than policy violation situations. For example, the action evaluation system can be enabled to detect when a user is having a medical emergency. Thus, although the user is not in violation of any passenger policies, the action evaluation system can still determine that a remote assistance session is necessary.

The policies in the policy database are determined based on the policies of the service entity that assigns passengers to the autonomous vehicle, the policies of a fleet operator, and the policies of the owner of the autonomous vehicle. In some examples, a policy may apply to all vehicles that are in contact with the service entity. In other examples, a specific fleet operator may have one or more policies that are unique to them.

When the action evaluation system determines that a passenger has violated one or more policies, the action evaluation system can notify the remote assistance request system of the violation. In response, the remote assistance request system can transmit a request for remote assistance to a remote assistant system via the communication system. Depending on the nature of the violation, the remote assistance request system can determine a specific assistance type from the remote operator. For example, the remote assistance request can request that the remote operator open a channel of communication between the operator and the one or more passengers. In this example, the remote operator can attempt to resolve the policy violation using communication with the passengers.

The remote assistance session can include the remote operator issuing commands to control the autonomous vehicle to aid in resolving the current policy violation. The communication system can transmit the request to the remote assistant system and receive responses from the remote assistance system including but not limited to control commands and communication from the remote operator.

Image data for the interior of an autonomous vehicle can depict a passenger sitting in the interior of the autonomous vehicle and one or more objects. In a specific example, the passenger can be holding a lit cigarette. The interior sensor data can be passed to the data analysis system. The data analysis system can use the object detector to determine that the passenger is holding a lit cigarette. For example, the data analysis system can include a machine-learned model that is trained (e.g., based on labeled image data, etc.) to evaluate the image data (e.g., the pixels, etc.) to detect the presence of a lit cigarette across one or more time intervals. In another example, the data analysis can include heuristics that can be used to process the image data to detect the presence of the lit cigarette within the interior of the cabin. The action evaluation system can then use information stored in the policy database to determine that the lit cigarette represents a violation of passenger policy. The remote assistance request system can then use the communication system to transmit a request for remote assistance to the remote assistance system.

The image data can include a passenger sitting in the interior of the autonomous vehicle with an arm extended out through the window of the vehicle. The interior sensor (in this case a camera device) transmits the image data to the data analysis system. The data analysis system employs the body pose estimation system to determine the location and pose of the passenger's body. Based on the detected body pose, the layout of the interior of the autonomous vehicle (e.g., which can be captured in a stored vehicle model representing the dimensions of the autonomous vehicle), and information about the current state of the vehicle's windows (e.g., whether the windows are up or down), the action evaluation system determines that the passenger has extended their arm outside of the vehicle. The action evaluation system can then access the policy database to determine whether this scenario is a violation of the passenger behavior policy. In this example, the passenger extending their limb outside of the autonomous vehicle can be determined to be a violation of passenger policy. In response, the remote assistance request system can initiate a remote assistance session.

In some examples, an autonomous vehicle can include a vehicle computing system. The vehicle computing system can be responsible for, among other functions, creating the control signals needed to effectively control an autonomous vehicle. The vehicle computing system can include an autonomy computing system. The autonomy computing system can include one or more systems that enable the autonomous vehicle to plan a route, receive sensor data about the environment, perceive objects within the vehicle's surrounding environment (e.g., other vehicles), predict the motion of the objects within the surrounding environment, generate trajectories based on the sensor data, and perception/predicted motion of the objects, and, based on the trajectory, transmit control signals to a vehicle control system and thereby enable the autonomous vehicle to move to its target destination. To accomplish these operations, the autonomy computing system can include, for example, a perception system, a prediction system, and a motion planning system.

To help maintain awareness of the vehicle's surrounding environment, the vehicle computing system (e.g., the perception system) can access sensor data from one or more sensors to identify static objects and/or dynamic objects (actors) in the autonomous vehicle's environment. To help determine its position within the environment (and relative to these objects), the vehicle computing system can use a positioning system and/or a communication system to determine its current location. Based on this location information, the vehicle computing system can access map data (e.g., HD map data, etc.) to determine the autonomous vehicle's current position relative to other objects in the world (e.g., bicycles, pedestrians, other vehicles, buildings, etc.), as well as map features such as, for example, lane boundaries, curbs, and so on.

The vehicle computing system (e.g., the perception system) can utilize the sensor data to identify one or more objects in the local environment of the autonomous vehicle. The sensor data can include, but is not limited to, data acquired via: camera sensors, LIDAR sensors, infrared sensors, and RADAR sensors. Using this sensor data, the vehicle computing system can generate perception data that describes one or more object(s) in the vicinity of the autonomous vehicle (e.g., current location, speed, heading, shape/size, etc.).

The generated perception data can be utilized to predict the future motion of the object(s). For example, the vehicle computing system (e.g., the prediction system) can use the perception data to generate predictions for the movement of one or more objects as an object trajectory including one or more future coordinates/points. In some implementations, the perception and prediction functions of the vehicle computing system can be included within the same system.

The vehicle computing system (e.g., motion planning system) can use the perception data, prediction data, map data, and/or other data to generate a motion plan for the vehicle. For example, a route can describe a specific path for the autonomous vehicle to travel from a current location to a destination location. The vehicle computing system can generate potential trajectories for the autonomous vehicle to follow as it traverses the route. Each potential trajectory can be executable by the autonomous vehicle (e.g., feasible for the vehicle control systems to implement). Each trajectory can be generated to comprise a specific amount of travel time (e.g., eight seconds, etc.)

The autonomous vehicle can select and implement a trajectory for the autonomous vehicle to navigate a specific segment of the route. For instance, the trajectory can be translated and provided to the vehicle control system(s) that can generate specific control signals for the autonomous vehicle (e.g., adjust steering, braking, velocity, and so on). The specific control signals can cause the autonomous vehicle to move in accordance with the selected trajectory.

More particularly, a service entity (e.g., service provider, owner, manager, platform) can use one or more vehicles (e.g., ground-based vehicles) to provide a vehicle service such as a transportation service (e.g., rideshare service), a courier service, a delivery service, etc. For example, the service entity (e.g., its operations computing system) can receive requests for vehicle services (e.g., from a user) and generate service assignments (e.g., indicative of the vehicle service type, origin location, destination location, and/or other parameters) for the vehicle(s) to perform. The vehicle(s) can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can obtain sensor data from the sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can be configured to communicate with one or more computing devices that are remote from the vehicle. For example, the autonomous vehicle can communicate with a remote computing system that can be associated with the service entity, such as the service entity's operations computing system, and/or a remote assistance computing. The service entity's operations computing system can include a plurality of system clients that can help the service entity monitor, communicate with, manage, etc. autonomous vehicles. In this way, the service entity can manage the autonomous vehicles to provide the vehicle services of the entity.

A user can provide (e.g., via a user computing device) a request for a vehicle service to an operations computing system associated with the service entity. The request can indicate the type of vehicle service that the user desires (e.g., a user transportation service, a delivery service, a courier service, etc.), one or more locations (e.g., an origin, destination, etc.), timing constraints (e.g., pick-up time, drop-off time, deadlines, etc.), a number of user(s) and/or items to be transported in the vehicle, other service parameters (e.g., a need for handicap access, handle with care instructions, etc.), and/or other information.

The operations computing system of the service entity can process the request and identify one or more autonomous vehicles that may be able to perform the requested vehicle services for the user. For instance, the operations computing system can identify which autonomous vehicle(s) are online with the service entity (e.g., available for a vehicle service assignment, addressing a vehicle service assignment, etc.). An autonomous vehicle can go online with a service entity by, for example, connecting with the service entity's operations computing system so that the vehicle computing system can communicate with the operations computing system via a network of the service entity. Once online, the operations computing system can communicate a vehicle service assignment indicative of the requested vehicle services and/or other data to the autonomous vehicle.

The service entity can engage with a variety of autonomous vehicle types to provide vehicle services. For example, some autonomous vehicles can be owned and operated by the service entity (e.g., a “first-party autonomous vehicle”), other autonomous vehicles associated with the service entity can be associated with a third-party entity such as, for example, an individual, an original equipment manufacturer (OEM), or another entity (e.g., a “third-party autonomous vehicle”). Another category of autonomous vehicles is possible wherein the autonomous vehicles include some combinations of the features of the first-party autonomous vehicles and the third-party autonomous vehicles. Such autonomous vehicles can be owned by an entity other than the service entity but might include software or hardware that is distributed by the service entity and thereby have the ability to more closely integrate with the service entity.

Even though the third-party autonomous vehicle may not be included in the fleet of autonomous vehicles of the service entity, the platforms of the present disclosure can allow such third-party autonomous vehicles to still be utilized to provide the vehicle services offered by the service entity, access its system clients, etc.

Various means can be configured to perform the methods and processes described herein. For example, a computing system can include data obtaining unit(s), passenger sensing unit(s), data analysis unit(s), communication unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain interior sensor data associated with an interior of an autonomous vehicle. For example, the passenger monitoring system can obtain interior sensor data from an autonomous vehicle. A data obtaining unit is one example of a means for obtaining interior sensor data associated with an interior of an autonomous vehicle as described herein.

For instance, the means can be configured to determine from the interior sensor data that the interior of the autonomous vehicle contains one or more passengers. For example, the passenger monitoring system can analyze interior sensor data to determine whether the interior of the autonomous vehicle includes a passenger. A passenger sensing unit is one example of a means for determining from the interior sensor data that the interior of the autonomous vehicle contains one or more passengers as described herein.

The means can be configured to analyze the interior sensor data to determine whether the one or more passengers are violating one or more passenger policies. For example, the passenger monitoring system can identify one or more objects in the interior of the autonomous vehicle and determine the position pose of one or more passengers. A data analysis unit is one example of a means for analyzing the interior sensor data to determine whether the one or more passengers are violating one or more passenger policies as described herein.

The means can be configured to, in response to determining that the one or more passengers are violating one or more passenger policies, automatically initiate a remote assistance session with a remote operator. For example, the passenger monitoring system can request a remote assistance session with the remote operator if at least one passenger is determined to be in violation of a passenger policy. A communication unit is one example of a means for analyzing the interior sensor data to determine whether the one or more passengers are violating one or more passenger policies as described herein.

The systems and methods described herein provide a number of technical effects and benefits. More particularly, the systems and methods of the present disclosure provide improved techniques for monitoring passenger behavior and initiating remote assistance sessions when needed to resolve issues created by passenger behavior. For instance, the passenger monitoring system (and its associated processes) can automatically analyze interior sensor data to determine whether any of the passengers are violating passenger policies and automatically initiate a remote assistance session. By having a system to automatically monitor passenger behavior and automatically initiating a remote assistance session with a remote operator, the time to respond to violations of passenger policy is reduced and, as a result, the safety of the autonomous vehicles and the passengers is increased.

Thus, the disclosed systems and methods can improve the speed and efficiency of responding to passenger behavior that violates one or more passenger policies. By improving response times, the safety of passengers can be increased and the damage done to autonomous vehicles can be reduced.

With reference to the figures, example embodiments of the present disclosure will be discussed in further detail.

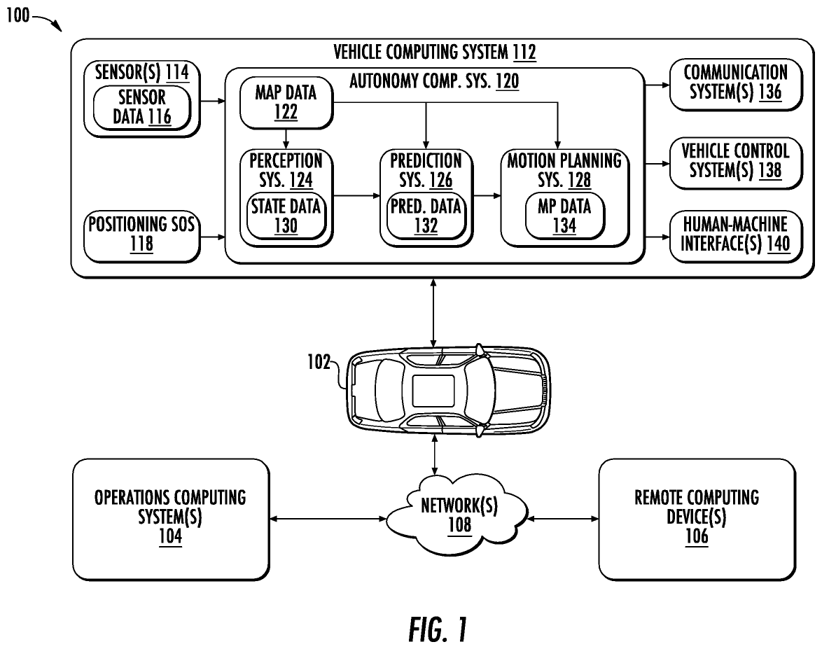

FIG. 1 depicts a block diagram of an example system 100 for controlling the navigation of a vehicle according to example embodiments of the present disclosure. As illustrated, FIG. 1 shows a system 100 that can include a vehicle 102; an operations computing system 104; one or more remote computing devices 106; a communication network 108; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider (e.g., service entity) that can provide one or more vehicle services to a plurality of users via a fleet of vehicles (e.g., service entity vehicles, third-party vehicles, etc.) that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of one or more vehicles (e.g., a fleet of vehicles), with the provision of vehicle services, and/or other operations as discussed herein.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing devices 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 102 including a location (e.g., latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, bike, scooter, other light electric vehicle, etc.), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, and/or the state of an environment to the operations computing system 104, which can store an indication, record, and/or other data indicative of the state of the vehicle. Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy system sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy system sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The autonomy system sensor data 116 can be indicative of locations associated with the one or more objects within the surrounding environment of the vehicle 102 at one or more times. For example, autonomy system sensor data 116 can be indicative of one or more LIDAR point clouds associated with the one or more objects within the surrounding environment. The one or more autonomy system sensors 114 can provide the autonomy system sensor data 116 to the autonomy computing system 120.

In addition to the autonomy system sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy system sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy system sensor data 116 from the one or more autonomy system sensors 114, attempt to determine the state of the surrounding environment by performing various processing techniques on the autonomy system sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on autonomy system sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around a vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a passenger seat in the back of the vehicle).

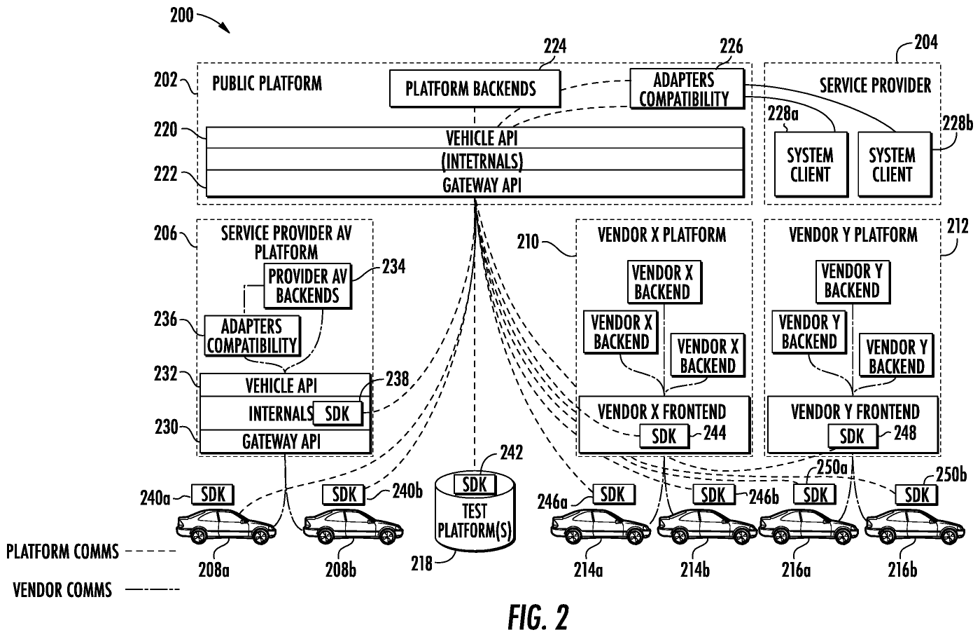

FIG. 2 depicts an example service infrastructure 200 according to example embodiments of the present disclosure. As illustrated in FIG. 2, an example service infrastructure 200, according to example embodiments of the present disclosure, can include an application programming interface platform (e.g., public platform) 202, a service provider system 204, a service provider autonomous vehicle platform (e.g., private platform) 206, one or more service provider autonomous vehicles (e.g., in a service provider fleet) such as autonomous vehicles 208a and 208b, and one or more test platforms 218. Additionally, the service infrastructure 200 can also be associated with and/or in communication with one or more third-party entity systems such as vendor platforms 210 and 212, and/or one or more third-party entity autonomous vehicles (e.g., in a third-party entity autonomous vehicle fleet) such as third-party autonomous vehicles 214a, 214b, 216a, and 216b. In some implementations, the VIP component described herein can include one or more of the platforms and related components illustrated in the service infrastructure 200 of FIG. 2.

As described herein, a service infrastructure 200 can include a public platform 202 to facilitate vehicle services (e.g., provided via one or more system clients (228a, 228b) associated with a service provider operations computing system) between the service provider system 204 (e.g., operations computing system, etc.) and vehicles associated with one or more entities (e.g., associated with the service provider (208a, 208b), associated with third-party entities (214a, 214b, 216a, 216b), etc.). For example, in some embodiments, the public platform 202 can provide access to service provider services (e.g., associated with the service provider system 204) such as trip assignment services, routing services, supply positioning services, payment services, and/or the like.

The public platform 202 can include a gateway API (e.g., gateway API 222) to facilitate communication from the autonomous vehicles to the service provider infrastructure services (e.g., system clients 228a, 228b, etc.) and a vehicle API (e.g., vehicle API 220) to facilitate communication from the service provider infrastructure services (e.g., system clients 228a, 228b, etc.) to the autonomous vehicles (e.g., 208a, 208b, 214a, 214b, 216a, 216b).

In some embodiments, the public platform 202 can be a logical construct that contains all vehicle and/or service facing interfaces. The public platform 202 can include a plurality of backend services interfaces (e.g., public platform backend interfaces 224). Each backend interface 224 can be associated with at least one system client (e.g., service provider system 204 clients such as system clients 228a and 228b). A system client (e.g., 228a, 228b, etc.) can be the hardware and/or software implemented on a computing system (e.g., operations computing system of the service provider) that is remote from the autonomous vehicle and that provides a particular back-end service to an autonomous vehicle (e.g., scheduling of vehicle service assignments, routing services, payment services, user services, etc.). A backend interface 224 can be the interface (e.g., a normalized interface) that allows one application and/or system (e.g., of the autonomous vehicle) to provide data to and/or obtain data from another application and/or system (e.g., a system client). Each backend interface 224 can have one or more functions that are associated with the particular backend interface. An autonomous vehicle can provide a communication to the public platform 202 to call a function of a backend interface. In this way, the backend interfaces can be an external facing edge of the service provider system 204 that is responsible for providing a secure tunnel for a vehicle and/or other system to communicate with a particular service provider system client (e.g., 228a, 228b, etc.) so that the vehicle and/or other system can utilize the backend service associated with that particular service provider system client (e.g., 228a, 228b, etc.), and vice versa.

In some embodiments, the public platform 202 can include one or more adapters 226, for example, to provide compatibility between one or more backend interfaces 224 and one or more service provider system clients (e.g., 228a, 228b, etc.). In some embodiments, the adapter(s) 226 can provide upstream and/or downstream separation between the service provider system 204 (e.g., system clients 228a, 228b, etc.) and the public platform 202 (e.g., backend interfaces 224, etc.). In some embodiments, the adapter(s) 226 can provide or assist with data curation from upstream services (e.g., system clients), flow normalization and/or consolidation, extensity, and/or the like.

The service infrastructure 200 can include a private platform 206 to facilitate service provider-specific (e.g., internal, proprietary, etc.) vehicle services (e.g., provided via one or more system clients (228a, 228b) associated with the service provider operations computing system) between the service provider system 204 (e.g., operations computing system, etc.) and autonomous vehicles associated with the service provider (e.g., autonomous vehicles 208a, 208b). For example, in some embodiments, the private platform 206 can provide access to service provider services that are specific to the service provider autonomous vehicle fleet (e.g., vehicles 208a and 208b) such as fleet management services, autonomy assistance services, and/or the like.

The private platform 206 can include a gateway API (e.g., gateway API 230) to facilitate communication from the autonomous vehicles 208a, 208b to one or more service provider infrastructure services (e.g., via the public platform 202, via one or more service provider autonomous vehicle backend interfaces 234, etc.) and a vehicle API (e.g., vehicle API 232) to facilitate communication from the service provider infrastructure services (e.g., via the public platform 202, via one or more service provider autonomous vehicle backend interfaces 234, etc.) to the autonomous vehicles 208a, 208b. The private platform 206 can include one or more backend interfaces 234 associated with at least one system client (e.g., service provider vehicle-specific system clients, such as fleet management, autonomy assistance, etc.). In some embodiments, the private platform 206 can include one or more adapters 236, for example, to provide compatibility between one or more service provider autonomous vehicle backend interfaces 234 and one or more private platform APIs (e.g., vehicle API 232, gateway API 230).

In some embodiments, the service infrastructure 200 can include a test platform 218 for validating and vetting end-to-end platform functionality, without use of a real vehicle on the ground. For example, the test platform 218 can simulate trips with human drivers and/or support fully simulated trip assignment and/or trip workflow capabilities.

The service infrastructure 200 can be associated with and/or in communication with one or more third-party entity systems, such as third-party entity (e.g., Vendor X) platform 210 and third-party entity (e.g., Vendor Y) platform 212, and/or one or more third-party entity autonomous vehicles (e.g., in a third-party entity autonomous vehicle fleet) such as third-party autonomous vehicles 214a, 214, 216a, and 216b. The third-party entity platforms 210, 212 can be distinct and remote from the service provide infrastructure and provide for management of vehicles associated with a third-party entity fleet, such as third-party entity (e.g., Vendor X) autonomous vehicles 214a, 214b and third-party entity (e.g., Vendor Y) autonomous vehicles 216a, 216b. The third-party entity (e.g., Vendor X) platform 210 and third-party entity (e.g., Vendor Y) platform 212, and/or third-party entity (e.g., Vendor X) autonomous vehicles 214a, 214b and third-party entity (e.g., Vendor Y) autonomous vehicles 216a, 216b can communicate with the service provider system 204 (e.g., system clients, etc.) via the public platform 202 to allow the third-party entity platforms and/or vehicles to access one or more service provider infrastructure services (e.g., trip services, routing services, payment services, user services, etc.). The service infrastructure 200 can include a plurality of software development kits (SDKs) (e.g., set of tools and core libraries), such as SDKs 238, 240a, 240b, 242, 244, 246a, 246b, 248, 250a, and 250b, that provide access to the public platform 202 for use by both the service provider autonomous vehicles (208a, 208b) and the third-party entity autonomous vehicles (214a, 214b, 216a, 216b). In some implementations, all external communication with the platforms can be done via the SDKs. For example, the provider entity infrastructure can include both a public SDK and a private SDK and specific endpoints to facilitate communication with the public platform 202 and the private platform 206, respectively. In some embodiments, the service provider autonomous vehicle fleet (e.g., vehicle 208a, 208b) and/or test platform 218 can use both the public SDK and the private SDK, whereas the third-party entity autonomous vehicles (vehicle 214a, 214b, 216a, 216b) can use only the public SDK and associated endpoints. In some implementations, the SDKs can provide a single-entry point into the service provider infrastructure (e.g., public platform 202, etc.), which can improve consistency across both the service provider fleet and the third-party entity fleet(s). As an example, a public SDK can provide secured access to the public platform 202 by both service provider vehicles and third-party entity (and/or systems) and access to capabilities such as trip assignment, routing, onboarding new vehicles, supply positioning, monitoring and statistics, a platform sandbox (e.g., for integration and testing), and/or the like. The private SDK can be accessed by the service provider vehicles and provide access to capabilities such as remote assistance, vehicle management, fleet management, and/or the like.

In some embodiments, the SDKs can include a command-line interface to provide an entry point into the SDK components and act as a gateway for SDK related work, integration, testing, and authentication. For example, the command-line tools can provide for bootstrapping, managing authentication, updating SDK version, testing, debugging, and/or the like. In some implementations, a command-line interface can require an authentication certificate before being able to bootstrap an SDK, download components, and/or access a service provider's services. For example, based on the authentication certificate, a command-line interface can determine which version of the SDK (e.g., public, or private) to which to provide access.

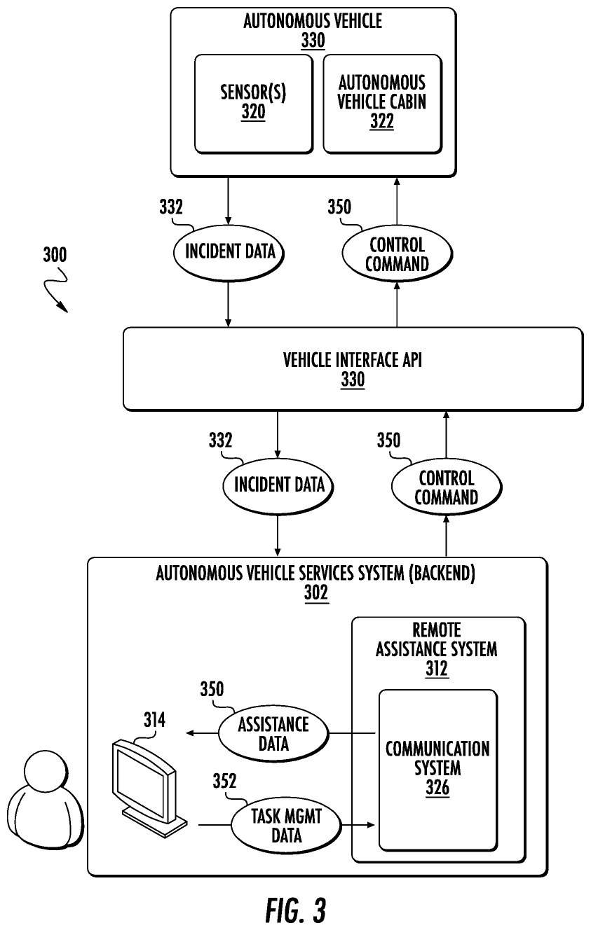

FIG. 3 depicts a block diagram of an example remote assistance service 300 according to example embodiments of the present disclosure. In some example embodiments, a remote assistance session can be associated with a remote assistance service 300. A remote assistance service 300 can be implemented by a remote assistance system which receives one or more requests for remote assistance from an autonomous vehicle 330 (e.g., automatically generated in response to one or more detected problems) or a passenger in an autonomous vehicle 330 (e.g., via an electronic device associated with the passenger such as a smartphone or tablet computer). By way of example, an autonomous vehicle 330 may determine, based on data received from one or more sensors (320) that a passenger in the autonomous vehicle cabin 322 has violated one or more passenger policies (e.g., sticking a limb out of a window). In response, the autonomous vehicle 330 (or a monitoring system included in the autonomous vehicle) can initiate a remote assistance session with a remote operator. To do so, the autonomous vehicle 330 can send (e.g., via its onboard communication system) a communication including a request to initiate a remote assistance session to the remote assistance system 312. In some examples, the monitoring system can be remote from the autonomous vehicle and receive sensor data from the autonomous vehicle to monitor for violations of passenger policies.

In some example embodiments, the remote assistance request can be first transmitted to a remote assist API 360, which allows autonomous vehicles 330 access to contact the autonomous vehicle services system 302 (and, in this case specifically, the remote assistance system 312). In some examples, the remote assist API 360 can provide a standardized interface for sending requests for remote assistance regardless of the particular autonomous vehicle 330 transmitting the request. Thus, third-party owned autonomous vehicles 330 can also transmit requests to the remote assist API 360, either directly or via a system controlled by the third-party before being relayed to the remote assist API 360.

The remote assist API 360 can transmit (or facilitate the transmittal) of the request for remote assistance to the autonomous vehicle services system 302. The request for remote assistance can include incident data 332. The autonomous vehicles services system 302 can direct the request to the remote assistance system 312. In another example, the remote assist API 360 can transmit the request directly to the remote assistance system 312 via the communication system.

The remote assist API 360 can help the back-end autonomous vehicle services system 302 to account for the various media capabilities of the various autonomous vehicles that are online with the service entity. For example, an autonomous vehicle 330 (e.g., a third-party autonomous vehicle, as further described) or a remote computing system associated therewith (e.g., a third-party vehicle provider computing system) can call a “streammediarequirements” RPC (e.g., a server-side streaming RPC), to establish and/or maintain a connection with the autonomous vehicle services system 302 to establish described media capabilities of autonomous vehicle 330. The autonomous vehicle 330 and/or another computing system can provide data indicative of the media capabilities of the autonomous vehicle 330. This can allow for a negotiation process to allow for the establishment of a communication session (e.g., for remote assistance).

Upon receiving a request for remote assistance from an autonomous vehicle 330, the remote assistance system 312 can assign an operator 370 to assist the requesting autonomous vehicle 330. In some example embodiments, the request for remote assistance may also be associated with particular request parameters. For example, the associated request parameters can include information identifying the specific autonomous vehicle 330, incident data 332 associated with the request (e.g., which policy was violated), information about the capabilities of the vehicle, the vendor that owns the vehicle, information describing autonomous driving software that is currently operating the autonomous vehicle, and the specific remote assistance actions that are available to the remote assistance system 312.

In some example embodiments, incident data 332 can include situational data for the autonomous vehicle. Situational data can include data describing the current situation of the vehicle including location, heading, velocity, the number and identities of passengers, and the data from any sensors included in the autonomous vehicle. Such sensors can include but are not limited to internal and external cameras, LIDAR sensors, and radar sensors. Also, the incident data 332 can identify what policy was broken, where and how the violation occurred, and which passenger committed the violation.

In some example embodiments, the remote assistance system 312 can identify one or more necessary pieces of data and transmit the relevant data to the assigned remote operator 370 as assistance data 354 for display on the user interface of a computer system. The remote assistance system 312 can be associated with a plurality of computer systems. One of the computer systems 314 can be associated with the assigned remote operator 370 for a particular remote assistance session. The remote assistance system 312 can display, in a remote assistance user interface at the computer system 314 of the remote operator 370, some or all of the vehicle, situation, and incident data 332 (e.g., called assistance data 354 when grouped together) accessed based on the request. For example, the user interface can include camera views relevant to the current situation (e.g., cameras that capture visual data from inside the cabin of the autonomous vehicle 330) as well as any captured audio data that may be relevant, and any other relevant sensor data.

In some example embodiments, the remote operator 370 can, through a remote assistance user interface, select a response option and/or communicate with the passengers of the vehicle. For example, the remote operator 370 can direct the autonomous vehicle to pull over to the side of the road to allow for a resolution to the passenger behavior that violated one or more passenger policies. In addition, the remote operator 370 can communicate with the passengers, explaining the current situation and requesting their help to resolve the situation.

Once the remote operator 370 has selected a particular response to the remote assist session, the computer system 314 can generate task management data 352 that can include audio or text information to communicate to the passengers of the passengers of the autonomous vehicle 330 and any commands to control the autonomous vehicle 330. The commands selected by the remote operator can be transmitted via the communication system 326 to the autonomous vehicle (through the remote assist API) as a control command 350.

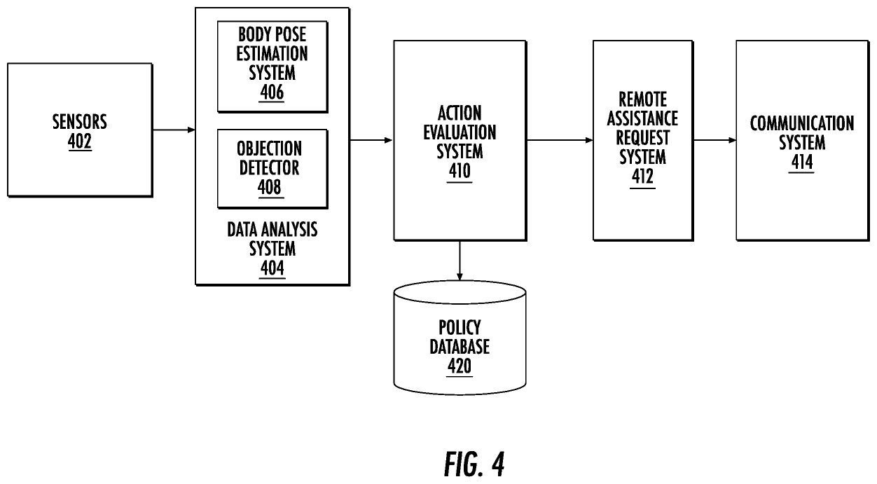

FIG. 4 depicts a block diagram of an example passenger monitoring system 400 according to example embodiments of the present disclosure. In some example embodiments, interior sensors 402 can gather data about the interior of an autonomous vehicle. For example, a camera can capture image data and a microphone can capture audio data, both the image data and the audio data being associated with the interior of a vehicle. In some examples, the gathered data can be transmitted to a data analysis system 404. The data analysis system 404 can be located in the autonomous vehicle itself. In other examples, the data analysis system 404 can be located remotely from the autonomous vehicle and the interior sensor data can be transmitted to the remotely located data analysis system 404.

In some examples, the data analysis system 404 can include a body pose estimation system 406 and an object detector 408. Each subsystem can analyze interior sensor data to determine one or more characteristics of the interior of the autonomous vehicle. In some examples, the data analysis system 404 can determine whether or not there are any passengers located in the autonomous vehicle. If at least one passenger is determined to be located inside the interior of the autonomous vehicle, the data analysis system 404 can determine whether that passenger is following one or more passenger policies. For example, the object detector 408 can analyze the image data to identify a list of objects present in the interior of the autonomous vehicle.

In some examples, the body pose estimation system 406 can use image data from the one or more interior sensors 402 to determine the location and pose of a particular passenger's body. In some examples, the process for determining a location and pose of a passenger's body can include using image data to identify one or more joint positions. The joint positions can be compared to reference data to identify the most likely pose for the passenger's body.

In some examples, the data analysis system 404 can capture a series of sequential images that represent one or more passengers inside the interior of an autonomous vehicle. The body pose estimation system 406 can generate an estimated location and pose for each passenger through the series of sequential images. Based on the changes in the user's body position and pose, the body pose estimation system 406 can estimate the movement of one or more passengers over time.

Once the data analysis system 404 has fully analyzed the interior sensor data (e.g., image data or audio data), the data analysis system 404 can transmit the results of the analysis to the action evaluation system 410. In some examples, the transmitted results can include a list of objects determined to be present by the object detector 408.

The action evaluation system 410 can use the data produced by the data analysis system 404 to determine whether or not the one or more passengers are in violation of one or more passenger policies stored in the policy database 420. For example, the action evaluation system 410 can, for each object in the list of objects, determine whether the item is allowed based on data stored in the policy database. In some examples, the action evaluation system 410 may also determine how the object is stored and whether it is being used. This information can be used to determine whether the user is violating a passenger policy. For example, some objects may be allowed if stored properly but disallowed if not stored properly. An antique samurai sword stored properly may be allowed while an openly carried machete may be in violation of a passenger policy.

Similarly, a user smoking a cigarette or using a vaping device may be in violation of a passenger policy but merely possessing those items may not be in violation of the policy. In some examples, items may be in violation of the policy regardless of how they are stored or used. For example, a passenger policy for a particular autonomous vehicle may indicate that no firearms are allowed in the autonomous vehicle, regardless of how they are stored. Thus, the action evaluation system 410 can determine which objects are present and whether the user has properly stored the object to fully determine whether one or more passenger policies have been violated.

In some examples, the action evaluation system 410 can also determine whether a user's actions violate a passenger policy. Specific examples of passenger policies the users may violate can include restrictions on what areas of the autonomous vehicle the user may access during the transportation service, restrictions on the interactions that are allowable between passengers, restrictions on damaging or otherwise negatively affecting the autonomous vehicle, and so on.

For example, a given autonomous vehicle may restrict which seats passengers are permitted to use. In some examples, the passenger policies set by the owner or manager of an autonomous vehicle can designate that the driver's seat and the passenger seat of an autonomous vehicle are out of bounds for passengers during the transportation service. Thus, if a user attempts to sit in either seat, the action evaluation system 410 can determine that the passenger is in violation of one or more passenger policies. In some examples, the passenger policies may restrict passengers from a first set of areas during the transportation service (e.g., while the autonomous vehicle is driving) and from a second set of areas before or after the transportation service. For example, a policy may allow a passenger to access an area of the autonomous vehicle to stow items in a trunk but not allow the passenger to access that area while the autonomous vehicle is in motion.

In another example, the passenger policies may prohibit violent altercations between two different passengers. The action evaluation system 410 can use the body pose estimation data to determine whether two passengers are currently involved in a violent altercation. In some examples, determining the movement of each passenger can allow the action evaluation system 410 to determine whether the users are involved in a violent altercation or are involved in acceptable behavior. In some examples, other data such as audio data can be used to distinguish unacceptable behavior from acceptable behavior.

Other examples can include passenger policies that prohibit a passenger from sticking their arms or other objects out the windows of a vehicle or through a sunroof. The action evaluation system 410 can determine whether or not a user has put a limb or other body parts or objects out of the vehicle in a way that is determined to be unsafe or in violation of one or more passenger policies. In another example, the action evaluation system 410 can determine that a passenger is damaging the autonomous vehicle and is thus in violation of a passenger policy.

It should be noted, that this action evaluation system 410 can be used to identify situations other than passenger policy violation situations. For example, the action evaluation system 410 can be enabled to detect when a user is having a medical emergency. Thus, although the user is not in violation of any passenger policies, the action evaluation system 410 can still determine that a remote assistance session is necessary.

In some examples, the passenger policies in the policy database 420 are determined based on the policies of the service entity that assigns passengers to the autonomous vehicle, the policies of a fleet operator, and the policies of the owner of the autonomous vehicle. In some examples, a policy may apply to all vehicles that operate with the service entity. In other examples, a specific fleet operator may have one or more policies that are unique to them.

When the action evaluation system 410 determines that a passenger has violated one or more passenger policies, the action evaluation system 410 can notify the remote assistance request system 412 of the violation. In response, the remote assistance request system 412 can transmit a request for remote assistance to a remote assistant system (e.g., remote assistance system 312 in FIG. 3) via the communication system 414. Depending on the nature of the violation, the remote assistance request system 412 can determine a specific assistance type from the remote operator. For example, the remote assistance request can request that the remote operator open a channel of communication between the operator and the one or more passengers. In this example, the remote operator can attempt to resolve the policy violation using communication with the passengers.

In another example, the remote assistance session can include the remote operator issuing commands to control the autonomous vehicle to aid in resolving the current policy violation. The communication system 414 can transmit the request to the remote assistant system (e.g., remote assistance system 312 in FIG. 3) and receive responses from their system including but not limited to control commands and communication from the remote operator.

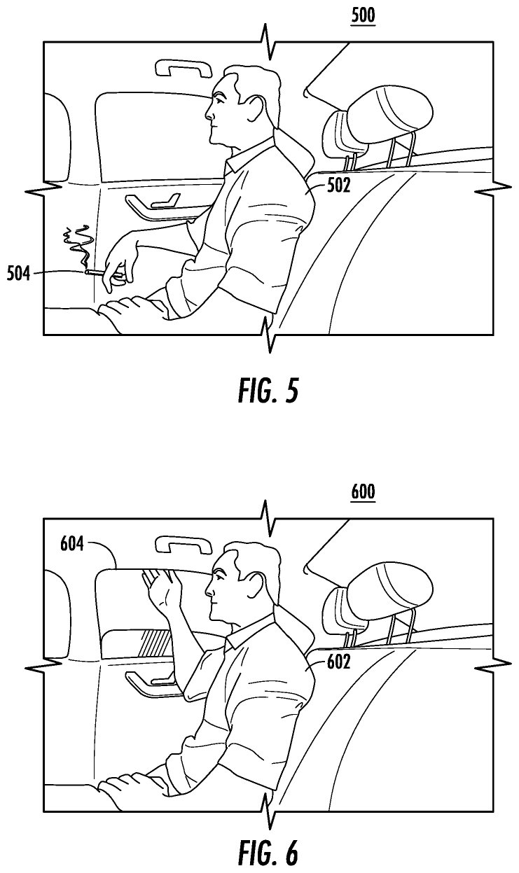

FIG. 5 is a representation of a camera view 500 of a passenger 502 in the interior of an autonomous vehicle according to example embodiments of the present disclosure. In some examples, image data for the interior of an autonomous vehicle can depict a passenger 502 sitting in the interior of the autonomous vehicle and one or more objects. In a specific example, the passenger 502 can be holding a lit cigarette 504. The interior sensor data can be passed to the data analysis system (e.g., data analysis system 404 in FIG. 4). The data analysis system (e.g., data analysis system 404 in FIG. 4) can use the object detector (e.g., object detector 408 in FIG. 4) to determine that the passenger is holding a lit cigarette 504. For example, the data analysis system (e.g., data analysis system 404 in FIG. 4) can include a machine-learned model that is trained (e.g., based on labeled image data, etc.) to evaluate the image data (e.g., the pixels that make up the image, patterns and edges within the image, etc.) to detect the presence of lit cigarette(s) across a plurality of time intervals. In another example, the data analysis system (e.g., data analysis system 404 in FIG. 4) can include heuristics that can be used to process the image data to detect the presence of the lit cigarette 504 within the interior of the cabin. The action evaluation system (e.g., action evaluation system 410 in FIG. 4) can then use information stored in the policy database (e.g. policy database 420 in FIG. 4) to determine that the lit cigarette 504 represents a violation of passenger policy. The remote assistance request system (e.g., remote assistance request system 412 in FIG. 4) can then use the communication system (e.g., communication system 414 in FIG. 4) to transmit a request for remote assistance to the remote assistance system (e.g., remote assistance system 312 in FIG. 3).

FIG. 6 is a representation of a camera view 600 of a passenger 602 in the interior of an autonomous vehicle according to example embodiments of the present disclosure. In another example, the image data can include a passenger 602 sitting in the interior of the autonomous vehicle with an arm extended out through the window 604 of the vehicle. The interior sensor (in this case a camera device) transmits the image data to the data analysis system (e.g., data analysis system 404 in FIG. 4). The data analysis system (e.g., data analysis system 404 in FIG. 4) can employ a body pose estimation system (e.g., body pose estimation system 406 in FIG. 4) to determine the location and pose of the passenger's body. Based on the detected body pose, the layout of the interior of the autonomous vehicle (e.g., which can be captured in a stored vehicle model representing the dimensions of the autonomous vehicle), and information about the current state of the vehicle's windows (e.g., whether the windows are up or down), the action evaluation system (e.g., action evaluation system 410 in FIG. 4) can determine that the passenger has extended their arm outside of the vehicle. The action evaluation system (e.g., action evaluation system 410 in FIG. 4) can then access the policy database (e.g., policy database 420 in FIG. 4) to determine whether this scenario is a violation of the passenger policy. In this example, the passenger 602 extending their limb outside of the autonomous vehicle can be determined to be a violation of passenger policy. In response, the remote assistance request system (e.g., remote assistance request system 412 in FIG. 4) can initiate a remote assistance session.

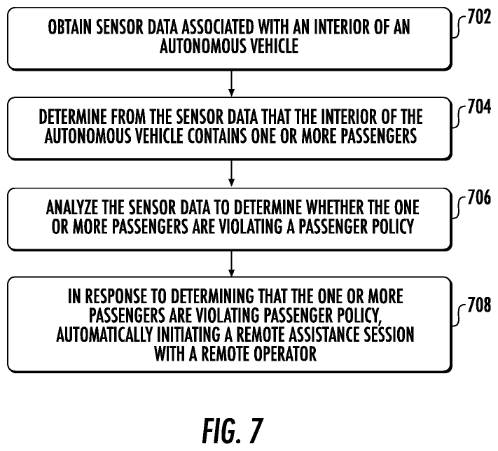

FIG. 7 depicts a flow chart diagram of an example method according to example embodiments of the present disclosure. One or more portion(s) of the method 700 can be implemented by one or more computing devices such as, for example, the computing devices described herein. Moreover, one or more portion(s) of the method 700 can be implemented as an algorithm on the hardware components of the device(s) described herein. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

In some examples, the passenger monitoring system (e.g., passenger monitoring system 400 in FIG. 4) can obtain, at 702, interior sensor data associated with an interior of an autonomous vehicle. For example, the obtained interior sensor data is received from interior sensors included in the autonomous vehicle. The interior sensor data received from the autonomous vehicle can be such that the data transfer rate at which interior sensor data is received from the autonomous vehicle is variable. The interior sensor data can include image data captured by a camera depicting the interior of the autonomous vehicle.

The passenger monitoring system (e.g., passenger monitoring system 400 in FIG. 4) can determine, at 704, using the interior sensor data, that the interior of the autonomous vehicle contains one or more passengers. In response to determining that the interior of the autonomous vehicle contains one or more passengers, the passenger monitoring system (e.g., passenger monitoring system 400 in FIG. 4) can analyze, at 706, the interior sensor data to determine whether the one or more passengers are violating one or more passenger policies.

For example, the passenger monitoring system (e.g., passenger monitoring system 400 in FIG. 4) can identify, based on the image data, an item possessed by the one or more passengers. The passenger monitoring system (e.g., passenger monitoring system 400 in FIG. 4) can determine whether the item is included in a list of prohibited items. Some examples of a prohibited item can include dangerous items (e.g., weapons), items that harm the autonomous vehicle interior or render it unsuitable for future passengers (e.g., lit cigarettes), or objects that are illegal or restricted in a given country or area. In response to determining that the item is included in the list of prohibited items, the passenger monitoring system (e.g., passenger monitoring system 400 in FIG. 4) can determine that the one or more passengers are violating one or more passenger policies.

The passenger monitoring system (e.g., passenger monitoring system 400 in FIG. 4) can determine a position and location of a body of a respective passenger of the one or more passengers based on the image data. For example, based on the determined position and location, the passenger monitoring system (e.g., passenger monitoring system 400 in FIG. 4) can determine whether a portion of the body of the respective passenger is outside of an area of the autonomous vehicle designated for passengers. For example, the passenger policies can prohibit the passenger from leaving a designated passenger area (e.g., the backseat of a vehicle) or extending a limb through a window.

In response to determining that a portion of the body of a respective passenger is outside of the area of the autonomous vehicle designated for passengers, the passenger monitoring system (e.g., passenger monitoring system 400 in FIG. 4) can determine, at 708, that the one or more passengers are violating one or more passenger policies. As noted above, determining whether a portion of the body of a passenger can include analyzing image data. The image data can include image data from more than one camera. Having image data from more than one camera can allow the passenger monitoring system (e.g., passenger monitoring system 400 in FIG. 4) to calculate the position of a passenger within the interior of the autonomous vehicle.

The passenger monitoring system (e.g., passenger monitoring system 400 in FIG. 4) can identify pose data for the one or more passengers based on image data. In some examples, identifying pose data can include determining one or more joint positions for a user based on the image data. The passenger monitoring system (e.g., passenger monitoring system 400 in FIG. 4) can identify the location of the one or more joint positions of the passenger within the three-dimensional space of the interior of the autonomous vehicle. Using this data, the passenger monitoring system (e.g., passenger monitoring system 400 in FIG. 4) can identify a pose of one or more passengers within the interior of the autonomous vehicle.

In some examples, the passenger monitoring system (e.g., passenger monitoring system 400 in FIG. 4) can determine a list of potential passenger scenarios associated with the one or more passengers based on the pose data. The passenger monitoring system (e.g., passenger monitoring system 400 in FIG. 4) can generate a confidence score for each potential passenger scenario from the list of potential scenarios, the confidence score for a particular potential passenger scenario from the list of potential passenger scenarios can indicate an estimated likelihood that the one or more passengers is participating in the particular potential passenger scenario from the list of potential passenger scenarios.

The passenger monitoring system (e.g., passenger monitoring system 400 in FIG. 4) can determine, for each respective potential passenger scenario in the list of potential passenger scenarios, whether the confidence score associated with the respective potential passenger scenario has a confidence score above a predetermined threshold. The passenger monitoring system (e.g., passenger monitoring system 400 in FIG. 4) can, in response to determining that a respective potential passenger scenario has a confidence score that exceeds the predetermined threshold, determine whether the respective potential passenger scenario is included in a list of banned passenger scenarios.

In accordance with a determination that at least one potential passenger scenario in the list of potential passenger scenarios is included in the list of banned passenger scenarios and has an associated confidence score that exceeds the predetermined threshold, the passenger monitoring system (e.g., passenger monitoring system 400 in FIG. 4) can determine that the one or more passengers are violating one or more passenger policies. The interior sensor data can include audio data captured by a microphone. The confidence scores can be generated, at least in part, based on audio data.

In response to determining that the one or more passengers are violating one or more passenger policies, the passenger monitoring system (e.g., passenger monitoring system 400 in FIG. 4) can automatically initiate a remote assistance session with a remote operator. In response to input from the remote operator, a remote assistance system can transmit a command to the autonomous vehicle that results in a change to the data transfer rate at which interior sensor data is received from the autonomous vehicle from a first rate to a second rate. In some examples, the resolution of the interior sensor data that is received from the autonomous vehicle is variable. Thus, a remote operator (or other remote system) can increase or decrease the transfer rate or resolution of the interior sensor data based on the needed resolution. While a remote assistance session is ongoing, a communication system can enable two-way communication between the one or more passengers and the remote operator. While a remote assistance session is ongoing, in response to input from a remote operator, the communication system can transmit one or more control commands to the autonomous vehicle.

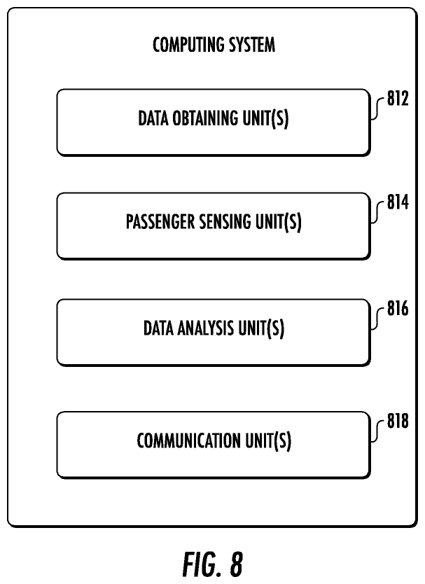

FIG. 8 depicts an example system with units for performing operations and functions according to example aspects of the present disclosure. Various means can be configured to perform the methods and processes described herein. For example, a computing system can include data obtaining unit(s) 812, passenger sensing unit(s) 814, data analysis unit(s) 816, communication unit(s) 818, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain interior sensor data associated with an interior of an autonomous vehicle. For example, the passenger monitoring system can obtain interior sensor data from an autonomous vehicle. A data obtaining unit 812 is one example of a means for obtaining interior sensor data associated with an interior of an autonomous vehicle as described herein.

The means can be configured to determine from the interior sensor data that the interior of the autonomous vehicle contains one or more passengers. For example, a passenger monitoring system can analyze interior sensor data to determine whether the interior of the autonomous vehicle includes a passenger. A passenger sensing unit 814 is one example of a means for determining from the interior sensor data that the interior of the autonomous vehicle contains one or more passengers as described herein.

The means can be configured to analyze the interior sensor data to determine whether the one or more passengers are violating one or more passenger policies. For example, a passenger monitoring system can identify one or more objects in the interior of the autonomous vehicle and determine the position pose of one or more passengers. A data analysis unit 816 is one example of a means for analyzing the interior sensor data to determine whether the one or more passengers are violating one or more passenger policies as described herein.

The means can be configured to, in response to determining that the one or more passengers are violating one or more passenger policies, automatically initiate a remote assistance session with a remote operator. For example, a passenger monitoring system can request a remote assistance session with the remote operator if at least one passenger is determined to be in violation of a passenger policy. A communication unit 818 is one example of a means for analyzing the interior sensor data to determine whether the one or more passengers are violating one or more passenger policies as described herein.

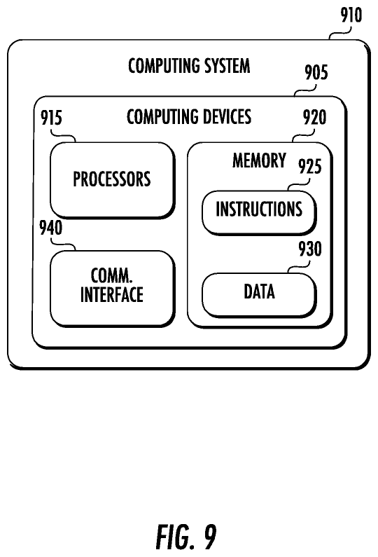

FIG. 9 depicts example system components according to example aspects of the present disclosure. The example system 900 illustrated in FIG. 9 is provided as an example only. The components, systems, connections, and/or other aspects illustrated in FIG. 9 are optional and are provided as examples of what is possible, but not required, to implement the present disclosure. The computing system 900 can be and/or include the vehicle computing system 112 of FIG. 1. The computing system 900 can be associated with a central operations system and/or an entity associated with the vehicle 105 such as, for example, a vehicle owner, vehicle manager, fleet operator, service provider, etc.

The computing device(s) 905 of the computing system 900 can include processor(s) 915 and at least one memory 920. The one or more processors 915 can be any suitable processing device (e.g., a processor core, a microprocessor, an ASIC, an FPGA, a controller, a microcontroller, etc.) and can be one processor or a plurality of processors that are operatively connected. The memory 920 can include one or more non-transitory computer-readable storage media, such as RAM, ROM, EEPROM, EPROM, one or more memory devices, flash memory devices, magnetic disks, data registers, etc., and combinations thereof.

The memory 920 can store information that can be accessed by the one or more processors 915. For instance, the memory 920 (e.g., one or more non-transitory computer-readable storage mediums, memory devices) can include computer-readable instructions 925 that can be executed by the one or more processors 915. The instructions 925 can be software written in any suitable programming language or can be implemented in hardware. Additionally, or alternatively, the instructions 925 can be executed in logically and/or virtually separate threads on processor(s) 915

For example, the memory 920 on-board the vehicle 105 can store instructions 925 that when executed by the one or more processors 915 cause the one or more processors 915 (e.g., in the vehicle computing system 112) to perform operations such as any of the operations and functions of the computing device(s) 905 and/or vehicle computing system 112, any of the operations and functions for which the vehicle computing system 112 is configured, and/or any other operations and functions described herein.

The memory 920 can store data 930 that can be obtained (e.g., received, accessed, written, manipulated, created, generated, etc.) and/or stored. The data 930 can include, for instance, services data (e.g., trip data, route data, user data, etc.), sensor data, map data, perception data, prediction data, motion planning data, object states and/or state data, object motion trajectories, and/or other data/information as described herein. In some implementations, the computing device(s) 905 can obtain data from one or more memories that are remote from the autonomous vehicle 102.

The computing device(s) 905 can also include a communication interface 940 used to communicate with one or more other system(s) (e.g., the remote computing system). The communication interface 940 can include any circuits, components, software, etc. for communicating via one or more networks (e.g., network(s)). In some implementations, the communication interface 940 can include, for example, one or more of: a communications controller, a receiver, a transceiver, a transmitter, a port, conductors, software, and/or hardware for communicating data.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method comprising:
obtaining, by a computing system comprising one or more computing devices, sensor data associated with an interior of an autonomous vehicle;
determining, by the computing system and using the sensor data, that the interior of the autonomous vehicle contains one or more passengers;
in response to determining that the interior of the autonomous vehicle contains one or more passengers, analyzing, by the computing system, the sensor data to determine whether the one or more passengers are violating one or more passenger policies; and
in response to determining that the one or more passengers are violating one or more passenger policies, automatically initiating, by the computing system, a remote assistance session with a remote operator.

2. The computer-implemented method of claim 1, wherein the sensor data includes image data captured by a camera depicting the interior of the autonomous vehicle.

3. The computer-implemented method of claim 2, wherein determining that the one or more passengers are violating one or more passenger policies further comprises:
identifying, by the computing system and based on the image data, an item possessed by the one or more passengers;
determining, by the computing system, whether the item is included in a list of prohibited items; and
in response to determining that the item is included in the list of prohibited items, determining, by the computing system, that the one or more passengers are violating one or more passenger policies.

4. The computer-implemented method of claim 3, wherein determining that the one or more passengers are violating one or more passenger policies can be based both on an item possessed by the one or more passengers and pose data for the one or more passengers.

5. The computer-implemented method of claim 2, wherein determining that the one or more passengers are violating one or more passenger policies further comprises:
determining, by the computing system, a position and location of a body of a respective passenger of the one or more passengers based on the image data;
based on the determined position and location, determining, by the computing system, whether a portion of the body of the respective passenger is outside of an area of the autonomous vehicle designated for passengers; and
in response to determining that a portion of the body of a respective passenger is outside of the area of the autonomous vehicle designated for passengers, determining, by the computing system, that the one or more passengers are violating one or more passenger policies.

6. The computer-implemented method of claim 5, wherein the image data includes image data from more than one camera.

7. The computer-implemented method of claim 2, wherein determining that the one or more passengers are violating one or more passenger policies further comprises:
identifying, by the computing system, pose data for the one or more passengers based on image data;
determining, by the computing system, a list of potential passenger scenarios associated with the one or more passengers based on the pose data; and
generating, by the computing system, a confidence score for each potential passenger scenario from the list of potential scenarios, the confidence score for a particular potential passenger scenario from the list of potential passenger scenarios indicating an estimated likelihood that the one or more passengers is participating in the particular potential passenger scenario from the list of potential passenger scenarios.

8. The computer-implemented method of claim 7, further comprising:
determining, by the computing system for each respective potential passenger scenario in the list of potential passenger scenarios, whether the confidence score associated with the respective potential passenger scenario has a confidence score above a predetermined threshold; and
in response to determining that a respective potential passenger scenario has a confidence score that exceeds the predetermine threshold, determining, by the computing system, whether the respective potential passenger scenario is included in a list of banned passenger scenarios.

9. The computer-implemented method of claim 8, further comprising:
in accordance with a determination that at least one potential passenger scenario in the list of potential passenger scenarios is included in the list of banned passenger scenarios and has an associated confidence score that exceeds the predetermined threshold, determining, by the computing system, that the one or more passengers are violating one or more passenger policies.

10. The computer-implemented method of claim 9, wherein the sensor data includes audio data captured by a microphone.

11. The computer-implemented method of claim 10, wherein confidence scores are generated, at least in part, based on audio data.

12. The computer-implemented method of claim 1, wherein the obtained sensor data is received from sensors included in the autonomous vehicle.

13. The computer-implemented method of claim 1, wherein a data transfer rate at which sensor data is received from the autonomous vehicle is variable.

14. The computer-implemented method of claim 12, further comprising:
in response to input from the remote operator, transmitting, by the computing system, a command to the autonomous vehicle that results in a change to the data transfer rate at which sensor data is received from the autonomous vehicle from a first rate to a second rate.

15. The computer-implemented method of claim 1, wherein a resolution of the sensor data that is received from the autonomous vehicle is variable.

16. The computer-implemented method of claim 1, further comprising:
while a remote assistance session is ongoing, enabling, by the computing system, two-way communication between the one or more passengers and the remote operator.

17. The computer-implemented method of claim 1, further comprising:
while a remote assistance session is ongoing, in response to input from a remote operator, transmitting, by the computing system, one or more control commands to the autonomous vehicle.

18. An autonomous vehicle, comprising:
one or more processors; and
one or more non-transitory computer-readable media that collectively store instructions that, when executed by the one or more processors, cause the one or more processors to perform operations, the operations comprising:
obtaining sensor data associated with an interior of an autonomous vehicle;
determining using the sensor data that the interior of the autonomous vehicle contains one or more passengers;
in response to determining that the interior of the autonomous vehicle contains one or more passengers, analyzing the sensor data to determine whether the one or more passengers are violating one or more passenger policies; and
in response to determining that the one or more passengers are violating one or more passenger policies, automatically initiating a remote assistance session with a remote operator.

19. The autonomous vehicle of claim 18, the operations further comprising:
while a remote assistance session is ongoing, in response to input from a remote operator, implementing one or more control commands for the autonomous vehicle based at least in part on the input from the remote operator.

20. A computing system comprising:
one or more processors; and
one or more tangible, non-transitory, computer readable media that collectively store instructions that when executed by the one or more processors cause the computing system to perform operations comprising:
obtaining sensor data associated with an interior of an autonomous vehicle;
determining using the sensor data that the interior of the autonomous vehicle contains one or more passengers;
in response to determining that the interior of the autonomous vehicle contains one or more passengers, analyzing the sensor data to determine whether the one or more passengers are violating one or more passenger policies; and
in response to determining that the one or more passengers are violating one or more passenger policies, automatically initiating a remote assistance session with a remote operator.
